(19) United States
(12) Patent Application Publication
(10) Pub. No.: US 2022/0392152 A1
(43) Pub. Date: Dec. 8, 2022

(54) METHOD FOR OPERATING COMPONENT, ELECTRONIC DEVICE, STORAGE MEDIUM AND PROGRAM PRODUCT

(71) Applicant: BEIJING BAIDU NETCOM SCIENCE TECHNOLOGY CO., LTD., Beijing (CN)

(72) Inventor: Ruizhi CHEN, Beijing (CN)

(73) Assignee: BEIJING BAIDU NETCOM SCIENCE TECHNOLOGY CO., LTD., Beijing (CN)

(21) Appl. No.: 17/819,739

(22) Filed: Aug. 15, 2022

(30) Foreign Application Priority Data
Mar. 7, 2022 (CN) 2022102257950

(51) Int. Cl. G06T 15/20; G06F 3/023; G06T 17/10; G06T 13/40

(52) U.S. Cl. CPC G06T 15/205; G06F 3/023; G06T 17/10; G06T 13/40

(57) ABSTRACT

The present application discloses a method for operating a component, an electronic device, a storage medium and a program product, relating to the field of artificial intelligence technology, such as, the computer vision technology, the image processing technology and the augmented reality technology, the method includes: in response to a drawing operation on an operable component in a three-dimensional virtual space, displaying a drawn two-dimensional pattern on the operable component; in response to a model generating operation on the operable component, processing the two-dimensional pattern to generate a three-dimensional model; and displaying the three-dimensional model in the three-dimensional virtual space. In the solution provided by the present disclosure, an operable component which may be applied in a virtual space is provided, and a user may draw a pattern in the operable component, thus enabling a system to generate a three-dimensional model corresponding to the pattern.

### CROSS-REFERENCE TO RELATED APPLICATIONS

This application claims priority to Chinese Patent Application No. 202210225795.0, filed on Mar. 7, 2022 and entitled “METHOD FOR OPERATING COMPONENT, ELECTRONIC DEVICE, STORAGE MEDIUM AND PROGRAM PRODUCT”, which is hereby incorporated by reference in its entirety.

### TECHNICAL FIELD

The present disclosure relates to the field of artificial intelligence technology, in particular, to the field of computer vision technology, image processing technology and augmented reality technology, and further in particular to, a method for operating a component, an electronic device, a storage medium and a program product.

### BACKGROUND

At present, a metaverse (Metaverse) is a collection of virtual time and space, which is a virtual world that is linked and created by scientific and technological means, and the metaverse is mapped to and interacts with the real world. The metaverse is a digital living space with anew social system. People may have a meeting, watch a show, socialize, and play a game, and the like in the metaverse.

Content of the metaverse is created by a professional three-dimensional-model modeling software, for example, a table, a car and the like in the metaverse are made by a developer using the three-dimensional-model modeling software in advance, and a user can use existing content of the metaverse.

However, in this way, the user can only use the existing content in the metaverse space, but cannot conduct more abundant interactions with the content in the metaverse space, resulting in poor interest.

### SUMMARY

The present disclosure provides a method for operating a component, an electronic device, a storage medium and a program product.

According to a first aspect of the present disclosure, a method for operating a component is provided, including:

in response to a drawing operation on an operable component in a three-dimensional virtual space, displaying a drawn two-dimensional pattern on the operable component;

in response to a model generating operation on the operable component, processing the two-dimensional pattern to generate a three-dimensional model; and

displaying the three-dimensional model in the three-dimensional virtual space.

According to a second aspect of the present disclosure, a method for operating a component is provided, including:

in response to a second control instruction on an operable component in a three-dimensional virtual space, controlling a preset surface of the operable component to be displayed in a mirror style;

determining a mirror image corresponding to a three-dimensional virtual avatar according to a relative position between the preset surface and the three-dimensional virtual avatar in the three-dimensional virtual space; and

displaying the mirror image of the three-dimensional virtual avatar in the preset surface.

According to a third aspect of the present disclosure, an electronic device is provided, which includes:

at least one processor; and

a memory communicatively connected to the at least one processor; where

the memory is stored with instructions executable by the at least one processor, and the instructions are executed by the at least one processor to enable the at least one processor to execute the method described in the first aspect.

The method for operating a component, the electronic device, the storage medium and the program product provided by the present disclosure includes: in response to a drawing operation on an operable component in a three-dimensional virtual space, displaying a drawn two-dimensional pattern on the operable component; in response to a model generating operation on the operable component, processing the two-dimensional pattern to generate a three-dimensional model; and displaying the three-dimensional model in the three-dimensional virtual space.

It should be understood that the content described in this section is not intended to point out the key or important features of embodiments of the present disclosure, nor to limit the scope of the present disclosure. Other features of the present disclosure will be easily understood through the following description.

### BRIEF DESCRIPTION OF DRAWINGS

The drawings are used for better understanding of the present scheme and do not constitute a limitation of the present disclosure.

FIG. 1 is a schematic flowchart of a method for operating a component according to a first exemplary embodiment of the present disclosure.

FIG. 2 is a schematic diagram of a virtual space shown in an exemplary embodiment of the present disclosure.

FIG. 3 is a schematic flowchart of a method for operating a component according to a second exemplary embodiment of the present disclosure.

FIG. 4 is a schematic flowchart of a method for operating a component according to a third exemplary embodiment of the present disclosure.

FIG. 5 is a schematic diagram of an operable component shown in an exemplary embodiment of the present disclosure.

FIG. 6 is a schematic flowchart of a method for operating a component according to a fourth exemplary embodiment of the present disclosure.

FIG. 7 is a schematic structural diagram of an apparatus for operating a component according to a first exemplary embodiment of the present disclosure.

FIG. 8 is a schematic structural diagram of an apparatus for operating a component according to a second exemplary embodiment of the present disclosure.

FIG. 9 is a schematic structural diagram of an apparatus for operating a component according to a third exemplary embodiment of the present disclosure.

FIG. 10 is a schematic structural diagram of an apparatus for operating a component according to a fourth exemplary embodiment of the present disclosure.

FIG. 11 is a block diagram of an electronic device used to implement the method of an embodiment of the present disclosure.

### DESCRIPTION OF EMBODIMENTS

In the following, exemplary embodiments of the present disclosure are described with reference to the accompanying drawings, which include various details of the embodiments of the present disclosure to facilitate understanding, and the described embodiments are merely exemplary. Therefore, persons of ordinary skill in the art should know that various changes and modifications can be made to the embodiments described herein without departing from the scope and spirit of the embodiments of the present disclosure. Also, for clarity and conciseness, descriptions of well-known functions and structures are omitted in the following description.

A virtual space, such as a metaverse, may be created through science technological means. In the metaverse, three-dimensional virtual avatars used to represent users may be created, and these three-dimensional virtual avatars may move in the metaverse. A developer may set up many virtual objects in the metaverse, and three-dimensional virtual avatars can use these objects under control of users. For example, there may exist a table, a chair and a car, etc., and the three-dimensional virtual avatar can sit on the chair and drive the virtual car.

However, these three-dimensional virtual avatars can only use these virtual objects, but cannot interact with the metaverse in more abundant way, resulting in less interesting interactions between users and the metaverse.

In order to solve the above technical problem, the present disclosure provides an operable component which may be applied to a three-dimensional virtual space. The operable component may be used as an artboard, a user may draw a pattern on the artboard, and a system of the metaverse may convert the two-dimensional pattern into a three-dimensional model, enabling the user to participate in a creation of the metaverse by adding a virtual object to the three-dimensional virtual space. The operable component may also be used as a mirror, which reflects an image of the three-dimensional virtual avatar as a mirror, and the user may further operate the operable component to perform personalized processing on the two-dimensional virtual image in the mirror to make it more interesting.

FIG. 1 is a schematic flowchart of a method for operating a component according to a first exemplary embodiment of the present disclosure.

As shown in FIG. 1, the method for operating a component provided by the present disclosure includes:

Step 101: in response to a drawing operation on an operable component in a three-dimensional virtual space, displaying a drawn two-dimensional pattern on the operable component.

Among them, the component provided by the present disclosure is an operable component, which may be set in a metaverse or another virtual space. The method provided by the present disclosure may be performed by a system of the metaverse or virtual space, and the system may be onboard in a computer.

In an implementation, the operable component may be packaged as an SDK package (Software Development Kit, software development kit), and a developer who develops the virtual space may use the SDK package to add an operable component in the virtual space.

For example, the operable component may be set on a roadside of the virtual space, and then the developer may add an operable component according to a location of the roadside.

Specifically, after an operable component is added to the virtual space, when a user operates a user terminal to display the virtual space, the operable component may be displayed. The user may further operate a three-dimensional avatar to use the operable component.

In this embodiment of the present disclosure, the operable component may be used as an artboard, and the user may operate the three-dimensional virtual avatar to draw a two-dimensional pattern on the operable component. In an implementation, the operable component may further be used as a mirror, and the user may operate the three-dimensional virtual avatar to stand in front of the minor, so that the operable component displays a mirror image of the three-dimensional virtual avatar.

Among them, the operable component displayed in the three-dimensional virtual space includes at least one plane or curved surface, and the three-dimensional virtual avatar may stand in front of the plane or curved surface and perform a drawing operation on the plane or curved surface of the operable component.

In an implementation, the operable component may be in a form of a tablet, with an operable plane or an operable curved surface.

In an implementation, the operable component may include multiple planes or curved surfaces, or may include both a plane and a curved surface. When the user operates any one of the planes or curved surfaces, the operated plane or curved surface may be locked, and after the plane or the curved surface is locked, another user cannot operate the plane or the curved surface. In this way, it can prevent other users from operating the plane or the curved surface, which would cause content drawn by the previous user to be destroyed.

Specifically, the operable component may have an operable keyboard, for example, a keyboard may be provided beside the operable component, and the user may operate the keyboard to activate an artboard function of the operable component. If the operable component includes multiple planes or curved surfaces, each surface may have an operable keyboard.

Furthermore, after activating the artboard function of the operable component, the user may control the three-dimensional avatar to perform a drawing operation on the operable component, and the system of the virtual space may display a drawn two-dimensional pattern based on the drawing operation of the three-dimensional avatar. For example, a movement trajectory of a hand or a brush held by the three-dimensional virtual avatar may be acquired, and then a drawn two-dimensional pattern may be generated according to the movement trajectory and displayed on the operable component, specifically displayed on a plane or a curved surface used as an artboard in the operable component.

Step 102: in response to a model generating operation on the operable component, processing the two-dimensional pattern to generate a three-dimensional model.

In practical application, after control of the three-dimensional virtual avatar to draw a two-dimensional pattern is completed, the user may further operate the operable component, so that the system of the metaverse may generate the three-dimensional model according to the two-dimensional pattern drawn by the user.

Among them, a key for operating the operable component may be set. For example, a “Complete” key may be displayed on the plane or the curved surface of the operable component, and the user may control the three-dimensional virtual avatar to click the complete key, so that the system may convert the two-dimensional pattern on the plane or the curved surface into the three-dimensional model.

Specifically, a technical capability of the corresponding three-dimensional model may be determined based on the content of the two-dimensional pattern. Three-dimensional virtual image generation (PTA, Photo To Avatar) based on a single image is generally divided into two types: a reconstruction type and a classification type. The reconstruction type relies on 3DMM (3D Morphable Face Model) or a deep neural network to perceive information in the single image and reconstruct the pattern, and construct a virtual image based on the reconstructed pattern; the classification type directly perceives a type of each part of the pattern in the single image, and selects the corresponding type from an existing type library and assembles them into a virtual image. A PTA-generated virtual image generally corresponds to a set of parameters that are used to represent the virtual image.

Step 103, displaying the three-dimensional model in the three-dimensional virtual space.

Furthermore, after the three-dimensional model is generated, the three-dimensional model may be displayed in the three-dimensional virtual space, so that user may add a model in the virtual space through his own operation, which can provide a richer way of interaction between the user and the virtual space.

In practical applications, the user may further control the three-dimensional virtual avatar to operate the generated three-dimensional model. For example, the three-dimensional virtual avatar may be controlled to touch the three-dimensional model, or grasp the three-dimensional model to move with the three-dimensional virtual avatar.

Among them, the three-dimensional model may also be fixed in any position as an ornament, for example, it may be tethered to back of a virtual car.

In an implementation manner, the generated three-dimensional model may be used as a pet of the three-dimensional virtual avatar and move with the three-dimensional virtual avatar. For example, a movement trajectory of the three-dimensional virtual avatar may be acquired, and the three-dimensional model generated through the three-dimensional virtual avatar may be controlled to move according to the above-mentioned movement trajectory.

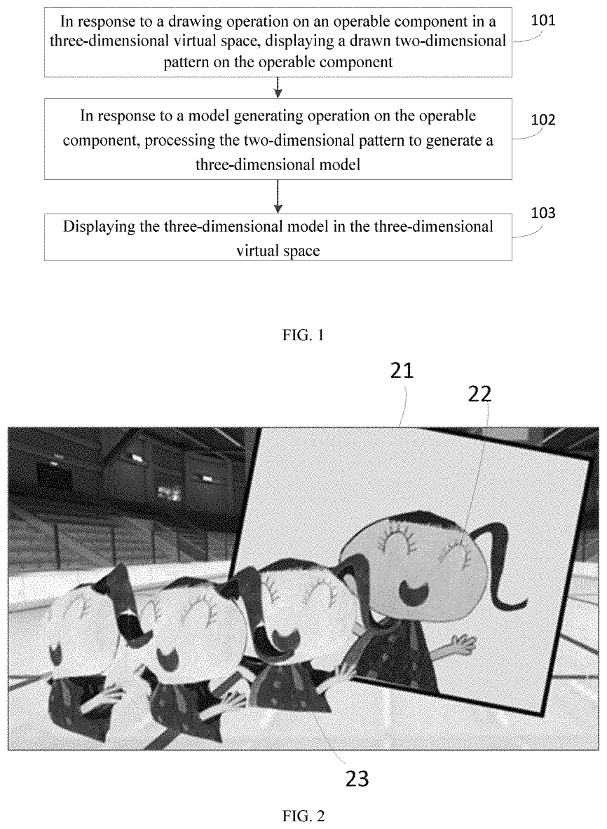

FIG. 2 is a schematic diagram of a virtual space shown in an exemplary embodiment of the present disclosure.

As shown in FIG. 2, an operable component 21 is provided in a virtual space, in which the user may operate and draw a pattern 22, the system may convert the two-dimensional pattern 22 into a three-dimensional model 23, and the three-dimensional model 23 may further move.

The method for operating a component provided by the present disclosure includes: in response to a drawing operation on an operable component in a three-dimensional virtual space, displaying a drawn two-dimensional pattern on the operable component; in response to a model generating operation on the operable component, processing the two-dimensional pattern to generate a three-dimensional model; and displaying the three-dimensional model in the three-dimensional virtual space. In the solution provided by the present disclosure, an operable component which may be applied in a virtual space is provided, and a user may draw a pattern in the operable component, thus enabling a system to generate a three-dimensional model corresponding to the pattern. In this way, the user can add a model in the virtual space through his own operation, thereby providing a richer way of interaction between the user and the virtual space.

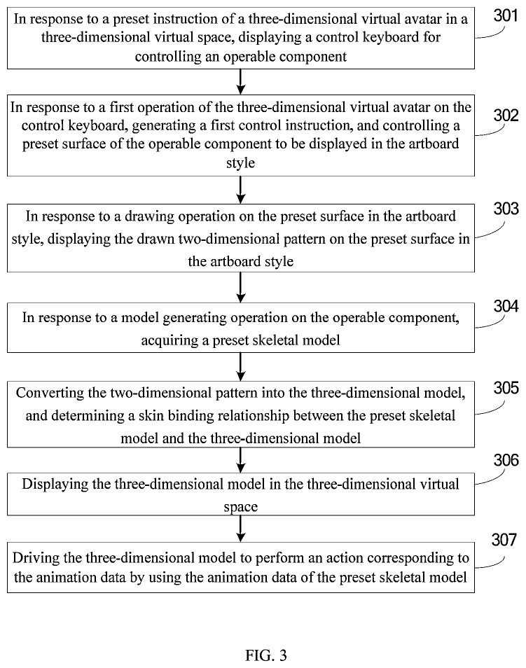

FIG. 3 is a schematic flowchart of a method for operating a component according to a second exemplary embodiment of the present disclosure.

As shown in FIG. 3, the method for operating a component provided by the present disclosure includes:

Step 301, in response to a preset instruction of a three-dimensional virtual avatar in a three-dimensional virtual space, displaying a control keyboard for controlling an operable component.

Among them, in the method provided by the present disclosure, the operable component may be displayed in an artboard style, or may be displayed in a mirror style. When the operable component is displayed in the artboard style, the user may control the three-dimensional virtual avatar to draw a pattern on the operable component, and when the operable component is displayed in the mirror style, the operable component may display a mirror image of the three-dimensional virtual avatar.

In this implementation, the operable component has a control keyboard. When the operable component is not operated, the control keyboard may not be displayed in the three-dimensional virtual space. The user may control the three-dimensional virtual avatar to walk near the operable component, and control the three-dimensional virtual avatar to perform a preset action, thereby triggering the system to display the control keyboard of the operable component in the three-dimensional virtual space.

For example, when the three-dimensional virtual avatar raises his right hand, the system displays the control keyboard of the operable component in the three-dimensional virtual space; for another example, when the three-dimensional virtual avatar sits on a chair next to the operable component, the system displays the control keyboard of the operable component in the three-dimensional virtual space.

Specifically, the control keyboard may be displayed beside the operable component, or connected with the operable component, thus making it convenient for the three-dimensional virtual avatar to operate the operable component. The control keyboard may be of a touch-type or a key-type, which is not limited in the present disclosure.

Step 302: in response to a first operation of the three-dimensional virtual avatar on the control keyboard, generating a first control instruction, and controlling a preset surface of the operable component to be displayed in the artboard style.

Furthermore, by operating the control keyboard, a function of the operable component may be selected, such as being used as an artboard, and another example is being used as a mirror.

In practical applications, when the user controls the three-dimensional virtual avatar to perform a first operation on the control keyboard, the system may generate the first control instruction for controlling the operable component in the three-dimensional virtual space.

For example, the control keyboard includes a first key that says “Artboard” and a second key that says “Mirror”. If the three-dimensional virtual avatar touches the first key that says “Artboard”, the system may generate a first control instruction for controlling the operable component; if the three-dimensional virtual avatar touches the second key that says “Mirror”, the system may generate a second control instruction for controlling the operable component.

In this implementation, when the operable component is not operated, its control keyboard is not displayed, so that a visual effect in the three-dimensional virtual space is better, and when the operable component can provide multiple functions, different functions of the operable component can be selected by operating the control keyboard.

Specifically, when the user performs the first operation on the operable component and sends the first control instruction thereto, the preset surface of the operable component is displayed in the artboard style. In this application scenario, the operated (manipulated) preset surface in the operable component is used as an artboard.

Furthermore, the preset surface may be a plane or a curved surface.

Step 303: in response to a drawing operation on the preset surface in the artboard style, displaying the drawn two-dimensional pattern on the preset surface in the artboard style.

Furthermore, after the preset surface of the operable component is displayed in the artboard style, the user may control the three-dimensional virtual avatar to perform the drawing operation on the preset surface.

In an implementation, a virtual brush may further be set in the artboard component, and the user may control the three-dimensional virtual avatar to pick up the brush and draw on the preset surface of the artboard component.

In another implementation, the user may control the three-dimensional virtual avatar to draw on the preset surface of the operable component with a finger.

Among them, the user may further control the three-dimensional virtual avatar to select a color used for drawing, for example, a color board may be displayed on the preset surface of the operable component, and the color used for drawing may be selected from the color board.

Specifically, the two-dimensional pattern may be generated according to a trajectory generated during the drawing operation, and the pattern may be displayed in the preset surface in the artboard style. For example, if the finger of the three-dimensional virtual avatar moves upward, a line is displayed on the preset surface according to a trajectory of movement of the finger.

In this embodiment, a solution for a user to draw a two-dimensional pattern in a three-dimensional virtual space can be provided, so that the system can convert the drawn two-dimensional pattern into a three-dimensional model, thereby making the solution more interesting.

Step 304: in response to a model generating operation on the operable component, acquiring a preset skeletal model.

Furthermore, after drawing the two-dimensional pattern, the user may further operate the three-dimensional virtual avatar to operate the operable component, thus enabling the system to generate the three-dimensional model corresponding to the two-dimensional pattern. A complete key may be set on the preset surface of the operable component, and the key may be clicked to trigger the system to generate the three-dimensional model corresponding to the two-dimensional pattern.

In practical applications, the system may acquire the preset skeletal model after the operation for generating a model is performed on the operable component.

In an implementation, the system may acquire multiple preset skeletal models, and the user controls the three-dimensional virtual avatar to select a skeletal model for generating the three-dimensional model among the preset skeletal models.

Among them, multiple default skeletal models may be displayed in the three-dimensional virtual space in response to the model generating operation on the operable component. The default skeletal models displayed may be either three-dimensional or two-dimensional.

Specifically, the user may control the three-dimensional virtual avatar to operate on the default skeletal models, so as to select a preset skeletal model for generating the three-dimensional model therefrom.

For example, a moving operation can be performed on any skeletal model in the default skeletal models, and an operated default skeletal model is the preset skeletal model. The preset skeletal model may be moved to a position where the two-dimensional pattern is located, to cause the preset skeletal model to overlap with the two-dimensional pattern.

In this way, a preset skeletal model for generating a three-dimensional model may be acquired based on an operation of the user, thereby generating a three-dimensional model that meets the needs of the user, so that the user can participate in the creation process of a virtual image in the virtual space.

In another implementation, the system may further acquire a corresponding preset skeletal model according to a shape or a type of the two-dimensional pattern.

Step 305, converting the two-dimensional pattern into the three-dimensional model, and determining a skin binding relationship between the preset skeletal model and the three-dimensional model.

The system may convert the two-dimensional pattern into the three-dimensional model, and specifically the three-dimensional model may be generated based on a solution in the prior art.

Among them, the system may further determine the skin binding relationship between the preset skeletal model and the three-dimensional model. The preset skeletal model has a corresponding animation. By determining the skin binding relationship between the preset skeletal model and the three-dimensional model, the animation may be used to drive the preset skeletal model to perform an action corresponding to the animation, and then drive the three-dimensional model to make a corresponding action.

For example, the animation corresponding to the preset skeletal model is a tail in skeletons swing, and a position that has a binding relationship with the tail in skeletons also swings when the tail in skeletons swings. In this way, the three-dimensional model can be made to perform actions.

In the solution provided by the present disclosure, through the interaction between the user and the three-dimensional virtual space, not only a three-dimensional model can be added to the three-dimensional virtual space, but also the three-dimensional model can be made to perform actions, thereby making it more interesting.

If the three-dimensional virtual avatar drags the preset skeletal model to the position where the two-dimensional pattern is located, the system may determine a skin binding between the three-dimensional model and skeletons according to a relative position between the three-dimensional model and the preset skeletal model.

Among them, a position where the three-dimensional model is located is consistent with a position where the two-dimensional pattern is located.

For example, an adjusted boundary of the three-dimensional model may be aligned with a boundary of the preset skeletal model according to the relative position between the three-dimensional model and the preset skeletal model, and then nodes in the preset skeletal model may be mapped to the three-dimensional model, so as to bind a corresponding relationship between the preset skeletal model and the three-dimensional model.

Specifically, when converting the two-dimensional pattern into the three-dimensional model, boundary clipping of a singly connected region may be performed on the two-dimensional pattern, and triangularization and texture mapping may be performed on each connected region, and then the two-dimensional pattern is meshed three-dimensionally according to a result of the triangularization and texture mapping, to generate the three-dimensional model.

Furthermore, if meshing is performed when the three-dimensional model is generated, the adjusted boundary of the three-dimensional model may be aligned with the boundary of the preset skeletal model by means of mesh alignment.

By binding the three-dimensional model and the preset skeletal model in this way, the three-dimensional model may act according to a posture of each node in the preset skeletal model, which is more interesting.

Step 306, displaying the three-dimensional model in the three-dimensional virtual space.

Step 306 is similar to Step 103 in FIG. 1, which will not be repeated here.

Step 307, driving the three-dimensional model to perform an action corresponding to the animation data by using the animation data of the preset skeletal model.

In practical applications, the preset skeletal model has the animation data, therefore, the animation data of the preset skeletal model may further be used to drive the three-dimensional model to perform the action corresponding to the animation data. For example, in the animation data of the preset skeletal model, a head of skeletons can swing left and right, then a part of the three-dimensional model bound to the head may also swing left and right.

In this way, the three-dimensional model may perform actions according to the animation data of the preset skeletal model, which is more interesting.

In an embodiment of the present disclosure, the operable component may further have a mirror function. The user may control the three-dimensional virtual avatar to perform a second operation on the operable component, causing the system to generate a second control instruction, and when the system receives the second control instruction, the operable component can be displayed in a mirror style.

Among them, the system may perform two-dimensionalization on the three-dimensional virtual avatar, to obtain a mirror image of the three-dimensional virtual avatar, and display the mirror image of the three-dimensional virtual avatar in the preset surface.

Specifically, in order to make the mirror image displayed in the operable component achieve an effect of actually looking in a mirror, the mirror image corresponding to the three- dimensional virtual avatar may be determined according to a relative position between the preset surface and the three-dimensional virtual avatar in the three-dimensional virtual space. For example, the two-dimensional mirror image may be generated according to a distance between each part of the three-dimensional virtual avatar and the preset surface, so that a distance between each part of the mirror image and a mirror surface is the same as the distance between each part of the three-dimensional virtual avatar and the preset surface.

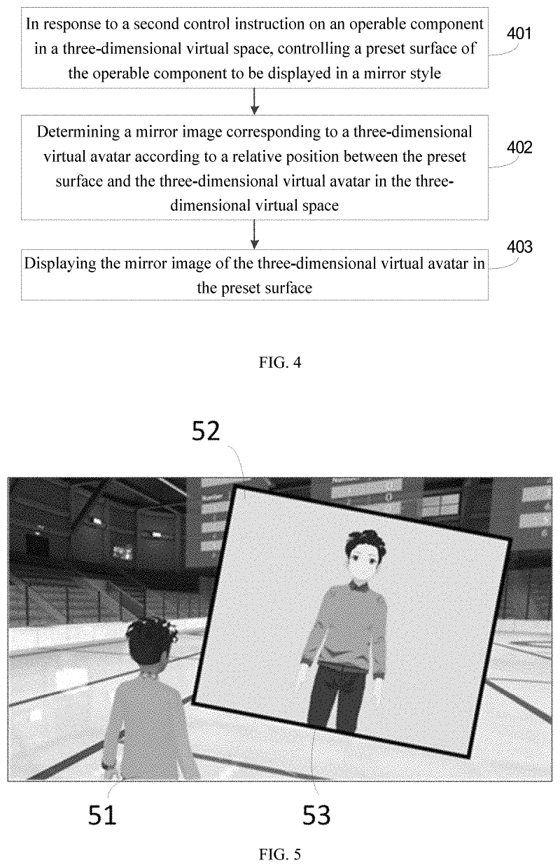

FIG. 4 is a schematic flowchart of a method for operating a component according to a third exemplary embodiment of the present disclosure.

As shown in FIG. 4, the method for operating a component provided by the present disclosure includes:

Step 401, in response to a second control instruction on an operable component in a three-dimensional virtual space, controlling a preset surface of the operable component to be displayed in a mirror style.

Among them, the component provided by the present disclosure is an operable component, which may be set in a metaverse or another virtual space. The method provided by the present disclosure may be performed by a system of the metaverse or virtual space, which may be onboard in a computer.

In an implementation, the operable component may be packaged as an SDK package (Software Development Kit, software development kit), and a developer who develops the virtual space may use the SDK package to add an operable component in the virtual space.

For example, the operable component may be set on a roadside of the virtual space, and then the developer may add an operable component according to a location of the roadside.

Specifically, after an operable component is added to the virtual space, when a user operates a user terminal to display the virtual space, the operable component may be displayed.

The user may further operate a three-dimensional avatar to use the operable component.

In an embodiment of the present disclosure, the operable component may further be used as a mirror, and the user may operate a three-dimensional virtual avatar to stand in front of the minor, so that the operable component displays a minor image of the three-dimensional virtual avatar. In an implementation, the operable component may be used as an artboard, and the user may operate the three-dimensional virtual avatar to draw a two-dimensional pattern on the operable component.

Among them, the operable component displayed in the three-dimensional virtual space includes at least one plane or curved surface, and the three-dimensional virtual avatar may stand in front of the plane or curved surface and perform a drawing operation on the plane or curved surface of the operable component.

In an implementation, the operable component may include multiple planes or curved surfaces, the user operates any one of the planes or curved surfaces, the operated plane or curved surface may be locked, and after the plane or the curved surface is locked, another user cannot operate the plane or the curved surface. In this way, simultaneous operations on the same plane or the curved surface by multiple users can be prevented.

Specifically, the operable component may have an operable keyboard, for example, a keyboard may be provided beside the operable component, and the user may operate the keyboard to activate an artboard function of the operable component. If the operable component includes multiple planes or curved surfaces, each of the planes or curved surfaces may have an operable keyboard.

In an implementation, the operable component may be in a form of a tablet, with an operable plane or curved surface.

Furthermore, after activating a mirror function of the operable component, the user may control the three-dimensional virtual avatar to perform various actions in front of the minor, and the operable component may display a mirror image of the three-dimensional virtual avatar.

Step 402: determining a mirror image corresponding to the three-dimensional virtual avatar according to a relative position between the preset surface and the three-dimensional virtual avatar in the three-dimensional virtual space.

In practical applications, the operable component may convert the three-dimensional virtual avatar into a two-dimensional mirror image according to a relative position between the three-dimensional virtual avatar and the preset surface.

Among them, the three-dimensional model may be rendered into a cartoon two-dimensional style rendering picture through stickers and a rendering shader. In one way, all shading transitions and model details during two-dimensional rendering may be expressed simply through sticker adjustments; in another way, a two-dimensional rendering shader is used, and the model sticker is adjusted with the shader, so as to obtain a better two-dimensional rendering result.

Specifically, in order to make the mirror function of the operable component more realistic, in the solution provided by the present disclosure, the mirror image corresponding to the three-dimensional virtual avatar may be determined based on the relative position between the three-dimensional virtual avatar and the preset surface.

Furthermore, the relative position includes a distance and an angle.

Step 403, displaying the mirror image of the three-dimensional virtual avatar in the preset surface.

In practical applications, the determined mirror image may further be displayed on the preset surface of the operable component, so as to achieve an effect of a three-dimensional virtual avatar looking in a mirror.

If the three-dimensional virtual avatar changes a posture, the operable component may re-determine a mirror image according to a current posture of the three-dimensional virtual avatar and a position relative to the preset surface, and display the mirror image in the preset surface.

FIG. 5 is a schematic diagram of an operable component shown in an exemplary embodiment of the present disclosure.

As shown in FIG. 5, the three-dimensional virtual avatar 51 stands in front of the operable component 52, and if the operable component 52 has activated the mirror function, the mirror image as shown in 53 may be displayed.

The method for operating a component provided by the present disclosure includes: in response to a second control instruction on an operable component in a three-dimensional virtual space, controlling a preset surface of the operable component to be displayed in a mirror style; determining a mirror image corresponding to a three-dimensional virtual avatar according to a relative position between the preset surface and the three-dimensional virtual avatar in the three-dimensional virtual space; and displaying the mirror image of the three-dimensional virtual avatar in the preset surface. In the method provided by the present disclosure, through an operation of a user on the operable component, a mirror function of the operable component can be activated, so that a mirror image of the three-dimensional virtual avatar can be displayed. This solution may provide a new type of interaction solution between the user and the virtual space, which is more interesting.

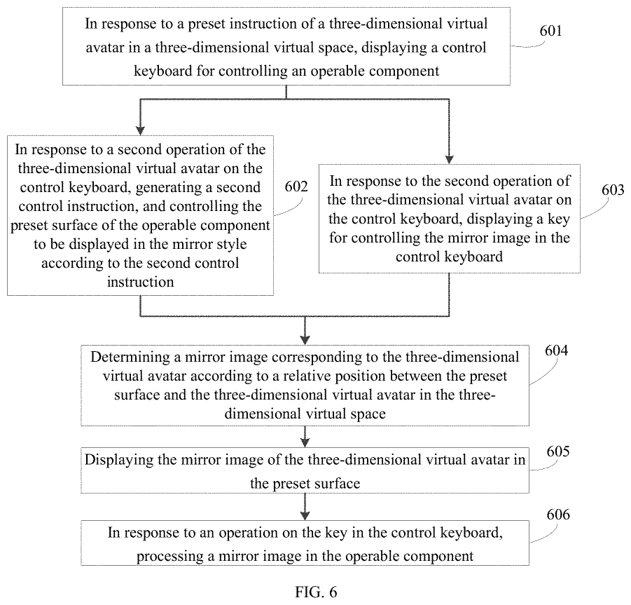

FIG. 6 is a schematic flowchart of a method for operating a component according to a fourth exemplary embodiment of the present disclosure.

As shown in FIG. 6, the method for operating a component provided by the present disclosure includes:

Step 601, in response to a preset instruction of a three-dimensional virtual avatar in a three-dimensional virtual space, displaying a control keyboard for controlling an operable component.

Among them, in the method provided by the present disclosure, the operable component may be displayed in a mirror style, or may be displayed in an artboard style. When the operable component is displayed in the mirror style, the operable component may display a mirror image of the three-dimensional virtual avatar, and when the operable component is displayed in the artboard style, the user may control the three-dimensional virtual avatar to draw a pattern in the operable component.

In this implementation, the operable component has a control keyboard. When the operable component is not operated, the control keyboard may not be displayed in the three-dimensional virtual space. The user may control the three-dimensional virtual avatar to walk near the operable component, and control the three-dimensional virtual avatar to perform a preset action, thereby triggering the system to display the control keyboard of the operable component in the three-dimensional virtual space.

For example, when the three-dimensional virtual avatar raises his right hand, the system displays the control keyboard of the operable component in the three-dimensional virtual space; for another example, when the three-dimensional virtual avatar sits on a chair next to the operable component, the system displays the control keyboard of the operable component in the three-dimensional virtual space.

Specifically, the control keyboard may be displayed beside the operable component, or connected with the operable component. It is convenient for the three-dimensional virtual avatar to operate the control keyboard. The control keyboard may be of a touch-type or a key-type, which is not limited in the present disclosure.

Step 602, in response to a second operation of the three-dimensional virtual avatar on the control keyboard, generating a second control instruction, and controlling the preset surface of the operable component to be displayed in the mirror style according to the second control instruction.

Furthermore, by operating the control keyboard, a function of the operable component may be selected, such as being used as a mirror, and another example is being used as an artboard.

In practical applications, when the user controls the three-dimensional virtual avatar to perform a second operation on the control keyboard, the system may generate the second control instruction for controlling the operable component in the three-dimensional virtual space.

For example, the control keyboard includes a first key that says “Artboard” and a second key that says “Mirror”. If the three-dimensional virtual avatar touches the first key that says “Artboard”, the system may generate a first control instruction for controlling the operable component; if the three-dimensional virtual avatar touches the second key that says “Mirror”, the system may acquire a second control instruction for controlling the operable component.

Specifically, when the user operates the operable component and sends the second control instruction thereto, the preset surface on the operable component is displayed in the mirror style. In this application scenario, the operated preset surface in the operable component is used as a mirror.

Step 603: in response to the second operation of the three-dimensional virtual avatar on the control keyboard, displaying a key for controlling the mirror image in the control keyboard.

Furthermore, in the method provided by the present disclosure, various operations may be performed on the mirror image displayed in the preset surface. In order to reduce the number of operations performed by the user, in the solution provided by the present disclosure, when the user performs the second operation on the control keyboard, the key for controlling the mirror image may be displayed in the control keyboard.

In practical applications, multiple keys for controlling the mirror image may be displayed in the control keyboard, and each key corresponds to a different control mode of the mirror image, such as changing a style, or changing a costume.

An order for executing Step 602 and Step 603 is not limited.

Step 604: determining a mirror image corresponding to the three-dimensional virtual avatar according to a relative position between the preset surface and the three-dimensional virtual avatar in the three-dimensional virtual space.

Step 605, displaying the mirror image of the three-dimensional virtual avatar in the preset surface.

Steps 604-605 are similar to corresponding content shown in FIG. 5, which will not be repeated.

Step 606, in response to an operation on the key in the control keyboard, processing a mirror image in the operable component.

Among them, after the mirror image of the three-dimensional virtual avatar is displayed in the preset surface of the operable component, the user may further control the three-dimensional virtual avatar to operate the key in the control keyboard, so that the component may process the mirror image according to a processing mode corresponding to the key.

In the solution provided by the present disclosure, multiple ways are provided to process the mirror image, so as to increase ways for interaction between the user and the virtual space, and to make it more interesting as well.

Specifically, the key includes a first key for adjusting an appearance style. If the user controls the three-dimensional virtual avatar to operate the first key, the system may adjust the appearance style of the mirror image displayed in the preset surface.

Furthermore, after the first key is operated, multiple appearance styles may be displayed in the operable component, the user may select any style among them, and the system may adjust the mirror image displayed in the preset surface to the selected appearance style.

In practical applications, multiple appearance styles may be preset, and the appearance style of the mirror image may be updated once every time the first button is operated, that is, the appearance style of the mirror image may be updated one by one using the preset appearance styles.

Among them, the key displayed in the control keyboard may further includes a second key for recording a video, and the user may control the three-dimensional virtual avatar to operate the second key, so that the system plays a preset audio, and stores the mirror image displayed in the preset surface.

In an implementation, after the second key is operated, a music list may be displayed in the operable component, the user may control the three-dimensional virtual avatar to select any music therein, and the system may play audio of the selected music.

Specifically, the user may control the three-dimensional virtual avatar to perform an action in front of the mirror, and the system may store the mirror image of the three-dimensional virtual avatar in the preset surface, so as to realize picture recording.

Furthermore, during recording of a video, if the user controls the three-dimensional virtual avatar to operate the second key in the control keyboard again, the recording may be stopped, and a video file including the audio and multiple frames of the mirror image is generated.

In practical applications, the stored file includes multiple consecutive frames of the mirror image of the three-dimensional virtual avatar, as well as the played audio. When playing such file, the stored audio may be played along with the recorded mirror image simultaneously.

Among them, the key in the control keyboard further includes a third key for changing a costume in the mirror image, the user may control the three-dimensional virtual avatar to operate the third key; and the system acquires an avatar costume from a costume library, and displays a minor image of the three-dimensional virtual avatar wearing the avatar costume in the operable component.

Specifically, the costume in the mirror image may be replaced with the acquired avatar costume by means of rendering.

Furthermore, after the user controls the three-dimensional virtual avatar to operate the third key, the system may display multiple avatar costumes in the operable component, any one of the avatar costumes may be selected, and the costume in the minor image is replaced with the selected avatar costume.

In practical applications, multiple avatar costumes may be displayed in the operable component;

when the user makes selections in the displayed avatar costumes, the system may determine a target avatar costume in response to a selecting instruction in the avatar costumes and display the mirror image of the three-dimensional virtual avatar wearing the target avatar costume in the operable component.

In an implementation of the present disclosure, the operable component may further have an artboard function.

The system may control a preset surface of the operable component to be displayed in an artboard style in response to a first control instruction on the operable component in the three-dimensional virtual space;

display a drawn two-dimensional pattern on the operable component in response to a drawing operation on the operable component; and

process the two-dimensional pattern to generate a three-dimensional model in response to a model generating operation on the operable component.

The implementation scheme in which the operable component is used as an artboard is similar to the embodiments described in any one of FIG. 1 to FIG. 3, which will not be repeated.

FIG. 7 is a schematic structural diagram of an apparatus for operating a component according to a first exemplary embodiment of the present disclosure.

The apparatus 700 for operating a component provided by the present disclosure includes:

a drawing unit 710, configured to display a drawn two-dimensional pattern on an operable component in response to a drawing operation on the operable component in a three-dimensional virtual space;

a model generating unit 720, configured to process the two-dimensional pattern to generate a three-dimensional model in response to a model generating operation on the operable component; and

a model displaying unit 730, configured to display the three-dimensional model in the three-dimensional virtual space.

In the apparatus for operating a component provided by the present disclosure, an operable component which may be applied in a virtual space is provided, and a user may draw a pattern in the operable component, thus enabling a system to generate a three-dimensional model corresponding to the pattern. In this way, the user can add a model in the virtual space through his own operation, thereby providing a richer way of interaction between the user and the virtual space.

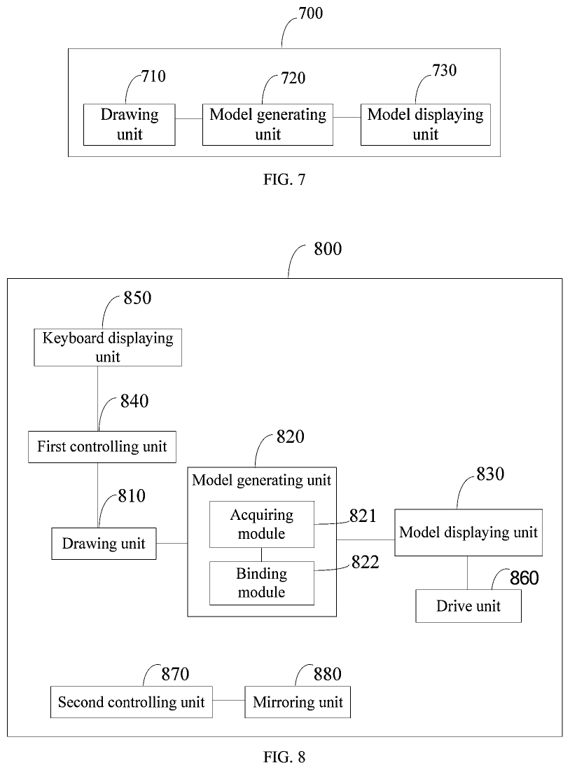

FIG. 8 is a schematic structural diagram of an apparatus for operating a component according to a second exemplary embodiment of the present disclosure.

In the apparatus 800 for operating a component provided by the present disclosure, the drawing unit 810 is similar to the drawing unit 710 shown in FIG. 7, the model generating unit 820 is similar to the model generating unit 720 shown in FIG. 7, and the model displaying unit 830 is similar to the model displaying unit 730 shown in FIG. 7.

The apparatus provided by the present disclosure further includes a first controlling unit 840, configured to: before the drawing unit 810 responds to the drawing operation on the operable component in the three-dimensional virtual space,

control a preset surface of the operable component to be displayed in an artboard style in response to a first control instruction on the operable component in the three-dimensional virtual space;

the drawing unit 810 is specifically configured to:

display the drawn two-dimensional pattern on the preset surface in the artboard style in response to a drawing operation on the preset surface in the artboard style.

The apparatus further includes a keyboard displaying unit 850, configured to: before the first controlling unit 840 controls the preset surface of the operable component to be displayed in the artboard style in response to the first control instruction on the operable component in the three-dimensional virtual space,

display a control keyboard for controlling the operable component in response to a preset instruction of a three-dimensional virtual avatar in the three-dimensional virtual space;

the first controlling unit 840 is specifically configured to:

in response to a first operation of the three-dimensional virtual avatar on the control keyboard, generate the first control instruction, and control the preset surface of the operable component to be displayed in the artboard style according to the first control instruction.

Among them, the model generating unit 820 includes:

an acquiring module 821, configured to acquire a preset skeletal model in response to the model generating operation on the operable component; and

a binding module 822, configured to convert the two-dimensional pattern into the three-dimensional model, and determine a skin binding relationship between the preset skeletal model and the three-dimensional model.

Among them, the acquiring module 821 is specifically configured to:

display multiple default skeletal models in the three-dimensional virtual space in response to the model generating operation on the operable component; and

move an operated skeletal model to a position where the two-dimensional pattern is located in response to a moving operation of the three-dimensional virtual avatar on any one of the default skeletal models, where the operated skeletal model is the preset skeletal model.

Among them, the binding module 822 is specifically configured to:

determine the skin binding relationship between the three-dimensional model and the preset skeletal model according to a relative position between the three-dimensional model and the preset skeletal model.

Among them, the preset skeletal model has animation data;

the apparatus further includes a drive unit 860, configure to:

drive the three-dimensional model to perform an action corresponding to the animation data by using the animation data of the preset skeletal model.

The apparatus further includes:

a second controlling unit 870, configured to control a preset surface of the operable component to be displayed in a mirror style in response to a second control instruction on the operable component in the three-dimensional virtual space; and

a mirroring unit 880, configured to determine a mirror image corresponding to a three-dimensional virtual avatar according to a relative position between the preset surface and the three-dimensional virtual avatar in the three-dimensional virtual space; and display the mirror image of the three-dimensional virtual avatar in the preset surface.

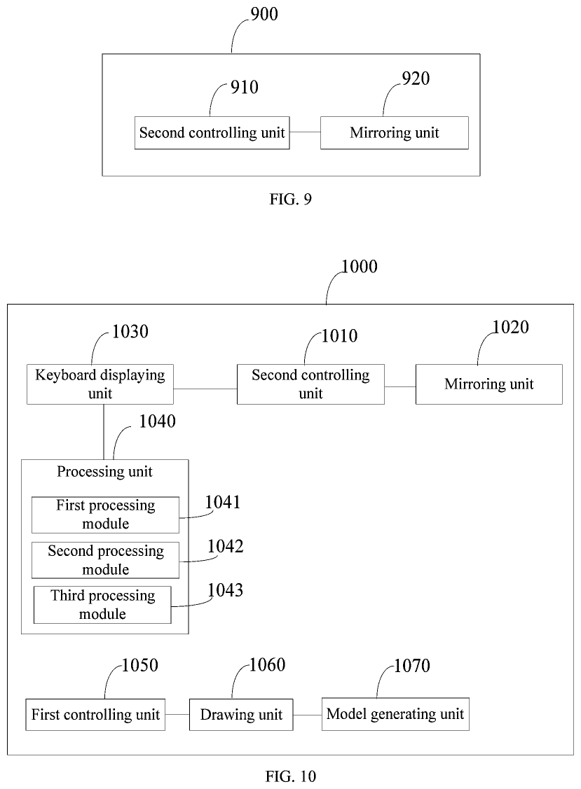

FIG. 9 is a schematic structural diagram of an apparatus for operating a component according to a third exemplary embodiment of the present disclosure.

As shown in FIG. 9, the apparatus 900 for operating a component provided by the present disclosure includes:

a second controlling unit 910, configured to control a preset surface of an operable component to be displayed in a mirror style in response to a second control instruction on the operable component in a three-dimensional virtual space; and

a mirroring unit 920, configured to determine a mirror image corresponding to a three-dimensional virtual avatar according to a relative position between the preset surface and the three-dimensional virtual avatar in the three-dimensional virtual space; and display the mirror image of the three-dimensional virtual avatar in the preset surface.

FIG. 10 is a schematic structural diagram of an apparatus for operating a component according to a fourth exemplary embodiment of the present disclosure.

The second controlling unit 1010 in FIG. 10 is similar to the second controlling unit 910 shown in FIG. 9, and the mirroring unit 1020 is similar to the mirroring unit 920 shown in FIG. 9.

The apparatus further includes a keyboard displaying unit 1030, configured to: before the second controlling unit 1010 controls the preset surface of the operable component to be displayed in the mirror style in response to the second control instruction on the operable component in the three-dimensional virtual space,

display a control keyboard for controlling the operable component in response to a preset instruction of a three-dimensional virtual avatar in the three-dimensional virtual space;

the second controlling unit 1010 is specifically configured to:

in response to a second operation of the three-dimensional virtual avatar on the control keyboard, generate the second control instruction, and control the preset surface of the operable component to be displayed in the mirror style according to the second control instruction.

In an implementation, the keyboard displaying unit 1030 is further configured to:

display a key for controlling the mirror image in the control keyboard in response to the second operation of the three-dimensional virtual avatar on the control keyboard;

the apparatus further includes a processing unit 1040, configured to process the mirror image in the operable component in response to an operation on the key in the control keyboard.

Among them, the key includes a first key for adjusting an appearance style, and the processing unit 1040 includes a first processing module 1041, configured to:

adjust an appearance style of the mirror image displayed in the preset surface in response to an operation on the first key in the control keyboard.

Among them, the key includes a second key for recording a video, and the processing unit 1040 includes a second processing module 1042, configured to:

in response to an operation on the second key in the control keyboard, play a preset audio, and store the mirror image displayed in the preset surface; and

generate a video file including the audio and multiple frames of the mirror image during recording of the video in response to the operation of the second key in the control keyboard.

Among them, the key includes a third key for changing a costume in the mirror image, and the processing unit 1040 includes a third processing module 1043, configured to:

acquire an avatar costume from a costume library in response to an operation on the third key in the control keyboard; and

display a mirror image of the three-dimensional virtual avatar wearing the avatar costume in the operable component.

Among them, the third processing module 1043 is specifically configured to:

display multiple avatar costumes in the operable component;

determine a target avatar costume in response to a selecting instruction in the avatar costumes; and

display the minor image of the three-dimensional virtual avatar wearing the target avatar costume in the operable component.

The apparatus further includes:

a first controlling unit 1050, configured to control a preset surface of the operable component to be displayed in an artboard style in response to a first control instruction on the operable component in the three-dimensional virtual space;

a drawing unit 1060, configured to display a drawn two-dimensional pattern on the operable component in response to a drawing operation on the operable component; and

a model generating unit 1070, configured to process the two-dimensional pattern to generate a three-dimensional model in response to a model generating operation on the operable component.

The present disclosure provides a method for operating a component, an electronic device, a storage medium and a program product, which are applied in the field of artificial intelligence technology, in particular, in the field of computer vision technology, image processing technology and augmented reality technology, which provides richer solutions for interacting with the metaverse space, thereby making it more interesting.

It should be noted that the minor image in this embodiment is not an image for a specific user, and cannot reflect personal information of a specific user.

In the technical solutions of the present disclosure, the collection, storage, use, processing, transmission, provision and disclosure of personal information of a user involved are in compliance with relevant laws and regulations, and do not violate public order and moral.

According to embodiments of the present disclosure, the present disclosure further provides an electronic device, a readable storage medium, and a computer program product.

According to an embodiment of the present disclosure, the present disclosure further provides a computer program product, where the computer program product includes: a computer program, and a computer program is stored in a readable storage medium, at least one processor of an electronic device can read the computer program from the readable storage medium, and at least one processor executes the computer program to make the electronic device execute the solution provided by any of the above embodiments.

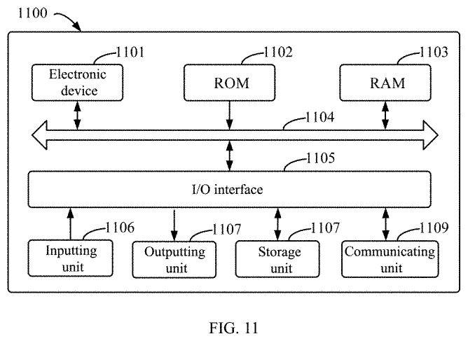

FIG. 11 shows a schematic block diagram of an example electronic device 1100 which can be used to implement embodiments of the present disclosure. The electronic device is intended to represent various forms of digital computers, such as a laptop computer, a desktop computer, a workbench, a personal digital assistant, a server, a blade server, a mainframe computer, and other suitable computers. The electronic device can also represent various forms of mobile apparatus, such as a personal digital processing, a cellular phone, a smart phone, a wearable device, and other similar computing apparatus. The components, their connections and relationships, and their functions herein are merely examples, and are not intended to limit an implementation of the present disclosure described and/or claimed herein.

As shown in FIG. 11, the electronic device 1100 includes a computing unit 1101, which may perform various appropriate actions and processes according to a computer program stored in a read-only memory (ROM) 1102 or a computer program loaded from a storage unit 1108 into a random access memory (RAM) 1103. In the RAM 1103, various programs and data required for the operation of the electronic device 1100 may also be stored. The computing unit 1101, the ROM 1102, and the RAM 1103 are connected to each other through a bus 1104. An input/output (I/O) interface 1105 is also connected to the bus 1104.

Multiple components in the electronic device 1100 are connected to the I/O interface 1105, including: an inputting unit 1106, such as a keyboard, a mouse, etc.; an outputting unit 1107, such as various types of displays, speakers, etc.; and a storage unit 1108, such as a magnetic disk, an optical disk, etc.; and a communicating unit 1109, such as an network card, a modem, a wireless communication transceiver, etc. The communicating unit 1109 allows the electronic device 1100 to exchange information/data with other devices through a computer network such as the Internet and/or various telecommunication networks.

The computing unit 1101 may be various general and/or special-purpose processing components with processing and computing capabilities. Some examples of the computing unit 1101 include, but are not limited to, a central processing unit (CPU), a graphics processing unit (GPU), various dedicated artificial intelligence (AI) computing chips, various computing units that run machine learning model algorithms, and a digital signal processing (DSP), as well as any appropriate processor, a controller, a microcontroller, etc. The computing unit 1101 executes the various methods and processes described above, such as the method for operating a component. For example, in some embodiments, the method for operating a component may be implemented as a computer software program, which is tangibly contained in a machine-readable medium, such as the storage unit 1108. In some embodiments, part or all of the computer program may be loaded and/or installed on the electronic device 1100 via the ROM 1102 and/or the communicating unit 1109. When the computer program is loaded into the RAM 1103 and executed by the computing unit 1101, one or more steps of the method for operating a component described above may be executed. Alternatively, in other embodiments, the computing unit 1101 may be configured to execute the method for operating a component through any other suitable means (for example, by a firmware).

The various implementations of the systems and technologies described above in this article can be implemented in a digital electronic circuit system, an integrated circuit system, a field programmable gate array (FPGA), an application-specific integrated circuit (ASIC), an application-specific standard product (ASSP), a system on chip system (SOC), a complex programmable logic device (CPLD), a computer hardware, a firmware, a software, and/or a combination thereof These various embodiments may include: being implemented in one or more computer programs, the one or more computer programs may be executed and/or interpreted on a programmable system including at least one programmable processor, the programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

The program code used to implement the method of the present disclosure can be written in any combination of one or more programming languages. The program code can be provided to a processor or a controller of a general-purpose computer, a special-purpose computer, or other programmable data processing apparatus, so that when the program code is executed by the processor or the controller, functions specified in the flowcharts and/or block diagrams are implemented. The program code may be executed entirely on a machine, partly executed on the machine, partly executed on the machine and partly executed on a remote machine as an independent software package, or entirely executed on a remote machine or a server.

In the context of the present disclosure, a machine-readable medium may be a tangible medium, which may contain or store a program for use by an instruction execution system, apparatus, or device or in combination with an instruction execution system, apparatus, or device. The machine-readable medium may be a machine-readable signal medium or a machine-readable storage medium. The machine-readable medium may include, but is not limited to electronic, magnetic, optical, electromagnetic, or infrared, or a semiconductor system, apparatus, or device, or any suitable combination of the foregoing. More specific examples of the machine-readable storage media would include electrical connections based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

In order to provide interaction with users, the systems and techniques described herein may be implemented on a computer, where the computer has: a display apparatus (for example, a CRT (cathode ray tube) or an LCD (liquid crystal display) monitor) for displaying information to users; and a keyboard and a pointing apparatus (for example, a mouse or a trackball) though which users may provide input to the computer. Other types of apparatus may also be used to provide interaction with users; for example, the feedback provided to users may be any form of sensing feedback (for example, visual feedback, audible feedback, or tactile feedback); and the input from users may be received in any form (including sound input, voice input, or tactile input).

The systems and techniques described herein may be implemented in a computing system that includes a back end component (for example, a data server), or a computing system that includes a middleware component (for example, an application server), or a computing system that includes a front end component (for example, a user computer with a graphical user interface or a web browser, through which the user can interact with the implementations of the systems and techniques described herein), or a computing system that includes any combination of such back end component, middleware component, or front end component. System components may be connected to each other by any form or medium of digital data communication (for example, a communication network). Examples of the communication network include: a local area network (LAN), a wide area network (WAN) and Internet.

A computer system may include a client and a server. The client and the server are generally far from each other and usually perform interactions through a communication network. A relationship between the client and the server is generated by computer programs running on corresponding computers and having a client-server relationship. The server may be a cloud server, also known as a cloud computing server or a cloud host, which is a host product in the cloud computing service system to solve the disadvantages of difficult management and weak business scalability in a traditional physical host and Virtual Private Server (VPS for short) service. The server may also be a server of a distributed system, or a server combined with a blockchain.

It should be understood that various forms of processes shown above can be used, and steps may be reordered, added, or deleted. For example, the steps described in the present disclosure may be performed in parallel or sequentially or in different orders. As long as desired results of the technical solutions disclosed in the present disclosure can be achieved, no limitation is made herein.

The above specific embodiments do not constitute a limitation to the protection scope of the present disclosure. Persons skilled in the art should know that various modifications, combinations, sub-combinations and substitutions can be made according to design requirements and other factors. Any modification, equivalent replacement and improvement made within the spirit and principle of the present disclosure shall be included in the protection scope of the present disclosure.

What is claimed is:

1. A method for operating a component, comprising:
in response to a drawing operation on an operable component in a three-dimensional virtual space, displaying a drawn two-dimensional pattern on the operable component;
in response to a model generating operation on the operable component, processing the two-dimensional pattern to generate a three-dimensional model; and
displaying the three-dimensional model in the three-dimensional virtual space.

2. The method according to claim 1, further comprising:
in response to a first control instruction on the operable component in the three-dimensional virtual space, controlling a preset surface of the operable component to be displayed in an artboard style;
wherein the in response to the drawing operation on the operable component in the three-dimensional virtual space, displaying the drawn two-dimensional pattern on the operable component comprises:
in response to a drawing operation on the preset surface in the artboard style, displaying the drawn two-dimensional pattern on the preset surface in the artboard style.

3. The method according to claim 2, further comprising:
in response to a preset instruction of a three-dimensional virtual avatar in the three-dimensional virtual space, displaying a control keyboard for controlling the operable component;
wherein the in response to the first control instruction on the operable component in the three-dimensional virtual space, controlling the preset surface of the operable component to be displayed in an artboard style comprises:
in response to a first operation of the three-dimensional virtual avatar on the control keyboard, generating the first control instruction, and controlling the preset surface of the operable component to be displayed in the artboard style according to the first control instruction.

4. The method according to claim 1, wherein the in response to the model generating operation on the operable component, processing the two-dimensional pattern to generate the three-dimensional model comprises:
in response to the model generating operation on the operable component, acquiring a preset skeletal model; and
converting the two-dimensional pattern into the three-dimensional model, and determining a skin binding relationship between the preset skeletal model and the three-dimensional model.

5. The method according to claim 4, wherein the in response to the model generating operation on the operable component, acquiring the preset skeletal model comprises:
in response to the model generating operation on the operable component, displaying multiple default skeletal models in the three-dimensional virtual space; and
in response to a moving operation of the three-dimensional virtual avatar on any one of the default skeletal models, moving an operated skeletal model to a position where the two-dimensional pattern is located, wherein the operated skeletal model is the preset skeletal model.

6. The method according to claim 4, wherein the determining the skin binding relationship between the preset skeletal model and the three-dimensional model comprises:
determining the skin binding relationship between the three-dimensional model and the preset skeletal model according to a relative position between the three-dimensional model and the preset skeletal model.

7. The method according to claim 6, wherein the preset skeletal model has animation data;
the method further comprises:
driving the three-dimensional model to perform an action corresponding to the animation data by using the animation data of the preset skeletal model.

8. The method according to claim 1, further comprising:
in response to a second control instruction on the operable component in the three-dimensional virtual space, controlling a preset surface of the operable component to be displayed in a mirror style;
determining a mirror image corresponding to a three-dimensional virtual avatar according to a relative position between the preset surface and the three-dimensional virtual avatar in the three-dimensional virtual space; an
displaying the mirror image of the three-dimensional virtual avatar in the preset surface.

9. A method for operating a component, comprising:
in response to a second control instruction on an operable component in a three-dimensional virtual space, controlling a preset surface of the operable component to be displayed in a mirror style;
determining a mirror image corresponding to a three-dimensional virtual avatar according to a relative position between the preset surface and the three-dimensional virtual avatar in the three-dimensional virtual space; and
displaying the mirror image of the three-dimensional virtual avatar in the preset surface.

10. The method according to claim 9, further comprising:
in response to a preset instruction of a three-dimensional virtual avatar in the three-dimensional virtual space, displaying a control keyboard for controlling the operable component;
wherein the in response to the second control instruction on the operable component in the three-dimensional virtual space, controlling the preset surface of the operable component to be displayed in the mirror style comprises:
in response to a second operation of the three-dimensional virtual avatar on the control keyboard, generating the second control instruction, and controlling the preset surface of the operable component to be displayed in the minor style according to the second control instruction.

11. The method according to claim 10, further comprising:
in response to the second operation of the three-dimensional virtual avatar on the control keyboard, displaying a key for controlling the minor image in the control keyboard; and
in response to an operation on the key in the control keyboard, processing the minor image in the operable component.

12. The method according to claim 11, wherein the key comprises a first key for adjusting an appearance style;
wherein the in response to the operation on the key in the control keyboard, processing the mirror image in the operable component comprises:
in response to an operation on the first key in the control keyboard, adjusting an appearance style of the mirror image displayed in the preset surface.

13. The method according to claim 11, wherein the key comprises a second key for recording a video;
wherein the in response to the operation on the key in the control keyboard, processing the mirror image in the operable component comprises:
in response to an operation on the second key in the control keyboard, playing a preset audio, and storing the mirror image displayed in the preset surface; and
in response to the operation of the second key in the control keyboard, generating a video file comprising the audio and multiple frames of the mirror image during recording of the video.

14. The method according to claim 11, wherein the key comprises a third key for changing a costume in the mirror image;
wherein the in response to an operation on the key in the control keyboard, processing the mirror image in the operable component comprises:
in response to an operation on the third key in the control keyboard, acquiring an avatar costume from a costume library; and
displaying a mirror image of the three-dimensional virtual avatar wearing the avatar costume in the operable component.

15. The method according to claim 14, wherein the acquiring the avatar costume from the costume library comprises:
displaying multiple avatar costumes in the operable component; and
in response to a selecting instruction in the avatar costumes, determining a target avatar costume;
wherein the displaying the mirror image of the three-dimensional virtual avatar wearing the avatar costume in the operable component comprises:
displaying the mirror image of the three-dimensional virtual avatar wearing the target avatar costume in the operable component.

16. The method according to claim 9, further comprising:
in response to a first control instruction on the operable component in the three-dimensional virtual space, controlling a preset surface of the operable component to be displayed in an artboard style;
in response to a drawing operation on the operable component, displaying a drawn two-dimensional pattern on the operable component; and
in response to a model generating operation on the operable component, processing the two-dimensional pattern to generate a three-dimensional model.

17. An electronic device, comprising:
at least one processor; and
a memory communicatively connected to the at least one processor;
wherein the memory is stored with instructions executable by the at least one processor, and the instructions are executed by the at least one processor to enable the at least one processor to:
in response to a drawing operation on an operable component in a three-dimensional virtual space, display a drawn two-dimensional pattern on the operable component;
in response to a model generating operation on the operable component, process the two-dimensional pattern to generate a three-dimensional model; and
display the three-dimensional model in the three-dimensional virtual space.

18. An electronic device, comprising:
at least one processor; and
a memory communicatively connected to the at least one processor;
wherein the memory is stored with instructions executable by the at least one processor, and the instructions are executed by the at least one processor to enable the at least one processor to execute the method according to claim 9.

19. A non-transitory computer readable storage medium stored with computer instructions, wherein the computer instructions are configured to enable a computer to execute method according to claim 1.

20. A non-transitory computer readable storage medium stored with computer instructions, wherein the computer instructions are configured to enable a computer to execute method according to claim 9.
